(19) United States
(12) Patent Application Publication
(10) Pub. No.: US 2026/0299693 A1
(43) Pub. Date: Oct. 1, 2026

(54) HAPTIC PRESENTATION APPARATUS, HAPTIC PRESENTATION METHOD, AND VEHICLE

(71) Applicant: Sony Group Corporation, Tokyo (JP)

(72) Inventors: Akira ONO, Kanagawa (JP); Hironobu ABE, Kanagawa (JP); Akihito NISHIIKE, Kanagawa (JP)

(21) Appl. No.: 19/477,573

(22) PCT Filed: Apr. 10, 2024
(86) PCT No.: PCT/JP2024/014482

§ 371 Date: Oct. 22, 2025

(30) Foreign Application Priority Data
May 31, 2023 (JP) 2023-089870

(51) Int. Cl. G06F 3/01; B60K 35/10; B60K 35/22; B60K 35/25

(52) U.S. Cl. CPC G06F 3/016; B60K 35/10; B60K 35/22; B60K 35/25; B60K 2360/126; B60K 2360/1438; B60K 2360/178

(57) ABSTRACT

A haptic presentation apparatus includes a deformable flexible layer that has flexibility, the flexible layer including a front surface that is exposed to be touchable by a user; a specification layer that specifies a shape of the flexible layer, the specification layer including a front surface that faces a back surface of the flexible layer; and a haptic generation unit that faces a back surface of the specification layer, the haptic generation unit being moved to a position that corresponds to a touch portion of the flexible layer that is a portion touched by the user, the haptic generation unit deforming the touch portion of the flexible layer.

### TECHNICAL FIELD

The present disclosure relates to a haptic presentation apparatus that presents a haptic sensation to a user, a haptic presentation method, and a vehicle that includes the haptic presentation apparatus.

### BACKGROUND ART

Various haptic presentation apparatuses are known. For example, Patent Literature 1 discloses a haptic presentation apparatus that uses a fluid transport apparatus and that includes a surface deformation apparatus including a surface that is deformed by expanding or contracting with a feed of fluid or no feed of fluid (paragraph [0037]). Patent Literature 2 discloses an electronic device capable of feeding back a result of a user operating a deformation interface to the user as needed (paragraph [0005]).

### CITATION LIST

### Patent Literature

Patent Literature 1: WO 2019/044111

Patent Literature 2: WO 2020/090266

### DISCLOSURE OF INVENTION

### Technical Problem

Typically, a haptic presentation position for a haptic presentation apparatus is specified. Thus, a user recognizes the haptic presentation position visually. However, shift of gaze may be desired to be avoided from the standpoint of safety or convenience.

In view of the circumstances described above, it is an object of the present disclosure to provide a haptic presentation apparatus for which it is not necessary for a user to recognize a haptic presentation position visually.

### Solution to Problem

A haptic presentation apparatus according to an embodiment of the present disclosure includes
a deformable flexible layer that has flexibility, the flexible layer including a front surface that is exposed to be touchable by a user;
a specification layer that specifies a shape of the flexible layer, the specification layer including a front surface that faces a back surface of the flexible layer; and
a haptic generation unit that faces a back surface of the specification layer, the haptic generation unit being moved to a position that corresponds to a touch portion of the flexible layer that is a portion touched by the user, the haptic generation unit deforming the touch portion of the flexible layer.

When haptic presentation is performed at a specified position, a haptic presentation position is specified literally. Thus, there is a need to give a user's awareness to the haptic presentation position. On the other hand, the present disclosure makes it possible to perform haptic presentation to any position touched by a user. Particularly in the case of being used by being mounted on a vehicle, there is no need to gaze at or give an awareness to a haptic presentation position. This results in securing safety. The haptic generation unit is moved to any position touched by a user and driving is performed at the position. This results in there being no need to provide haptic generation units to all of regions on the surface. This results in obtaining a simple structure and thus in contributing toward reducing costs.

The specification layer may include through holes that are each opened to face the flexible layer, and
the haptic generation unit may deform the flexible layer by fluid being sucked in through at least one of the through holes of the specification layer from a direction of the flexible layer and/or by the fluid being discharged through the at least one of the through holes of the specification layer in the direction of the flexible layer.

When fluid is a drive source, remote operation or driving performed at any position (driving can be performed according to the formation of a flow path) is suitable. When the air in the outside world is a drive source, placement can be performed regardless of location. Further, a surface shape is changed due to fluid being sucked in or discharged. This results in obtaining a simple structure and thus in contributing toward reducing costs.

The haptic generation unit may include an annular member that is in contact with the back surface of the specification layer,
in the haptic generation unit, the fluid may be sucked in from a fluid room that is partitioned off by the back surface of the specification layer and an inner side of the annular member, and
the haptic generation unit may deform a region of the flexible layer by the fluid being sucked in from an inner fluid room, the region being specified by a shape of the annular member.

Due to a change in frictional state, the user can haptically recognize that the touch portion of the flexible layer is deformed to have an uneven surface.

The haptic generation unit may include a ring-shaped inner annular member that is in contact with the back surface of the specification layer, and
a ring-shaped outer annular member that is in contact with the back surface of the specification layer, the outer annular member surrounding the inner annular member,
in the haptic generation unit, the fluid may be sucked in from an outer fluid room that is partitioned off by the back surface of the specification layer, the inner annular member, and the outer annular member, and
the haptic generation unit may deform a region of the flexible layer by the fluid being sucked in from and/or discharged into an inner fluid room that is partitioned off by the back surface of the specification layer and an inner side of the inner annular member, the region being specified by a shape of the annular member.

In the present embodiment, a contour of a deformation region of the flexible layer can be specified by fluid being sucked in from the outer fluid room.

The inner annular member of the haptic generation unit may be arranged around a single through hole that corresponds to the touch portion,
by the fluid being sucked in from the inner fluid room to pull the flexible layer into the single through hole, the haptic generation unit may deform the flexible layer so that the flexible layer has a concave surface, and
by the fluid being discharged into the inner fluid room to expand the flexible layer, the haptic generation unit may deform the flexible layer so that the flexible layer has a convex surface.

In the present embodiment, different kinds of haptic sensation can be presented to the user by the in-common touch portion being deformed into two different kinds of shapes.

The inner annular member of the haptic generation unit may be arranged correspondingly to the through holes being very small and corresponding to the touch portion,
by the fluid being sucked in from the inner fluid room to pull the flexible layer into the very small through holes, the haptic generation unit may deform the flexible layer so that the flexible layer has an uneven surface, and
by the fluid being discharged into the inner fluid room to expand the flexible layer, the haptic generation unit may deform the flexible layer so that the flexible layer has a convex surface.

In the present embodiment, different kinds of haptic sensation can be presented to the user by the in-common touch portion being deformed into two different kinds of shapes.

The haptic generation unit may vibrate the flexible layer by the fluid being sucked in from and discharged into the inner fluid room repeatedly and continuously.

Each of a shape change that provides haptic presentation, and a frictional change obtained by microscopically viewing the shape change is a change in state between a concave surface and a convex surface, and a negative-pressure fluid and a positive-pressure fluid are suitably drive sources.

The specification layer may include the through holes having different sizes, and
the haptic generation unit may present different kinds of haptic sensation by the fluid being sucked in from and/or discharged into the through holes having different sizes.

This makes it possible to present a combination of different kinds of haptic sensation to a user and to chronologically present a periodically changed haptic sensation to the user.

The haptic generation unit may be further moved in a thickness direction of the flexible layer.

Due to such movement, the air-and liquid-tight state may be created more positively.

The haptic presentation apparatus may further include a sensor that detects the touch portion of the flexible layer.

The sensor detects, for example, a resistance value, capacitance, piezoelectricity, a fluid pressure, an amount of light received, and sound and may detect a combination thereof.

A haptic presentation method according to an embodiment of the present disclosure is a haptic presentation method that is performed by a haptic presentation apparatus that includes
a deformable flexible layer that has flexibility, the flexible layer including a front surface that is exposed to be touchable by a user,
a specification layer that specifies a shape of the flexible layer, the specification layer including a front surface that faces a back surface of the flexible layer, and
a haptic generation unit,
the haptic presentation method including:
moving the haptic generation unit facing a back surface of the specification layer to a position that corresponds to a touch portion of the flexible layer that is a portion touched by the user; and
deforming the touch portion of the flexible layer using the haptic generation unit.

A vehicle according to an embodiment of the present disclosure includes
a haptic presentation apparatus that includes
   a deformable flexible layer that has flexibility, the flexible layer including a front surface that is exposed to be touchable by a user,
   a specification layer that specifies a shape of the flexible layer, the specification layer including a front surface that faces a back surface of the flexible layer, and
   a haptic generation unit that faces a back surface of the specification layer, the haptic generation unit being moved to a position that corresponds to a touch portion of the flexible layer that is a portion touched by the user, the haptic generation unit deforming the touch portion of the flexible layer.

### BRIEF DESCRIPTION OF DRAWINGS

FIG. 1 is a perspective view of a primary portion of a haptic presentation apparatus according to a first embodiment of the present disclosure.

FIG. 2 is a side view of the primary portion of the haptic presentation apparatus.

FIG. 3 schematically illustrates deformation of the haptic presentation apparatus.

FIG. 4 illustrates a hardware configuration of the haptic presentation apparatus.

FIG. 5 is a flow of operation performed by the haptic presentation apparatus.

FIG. 6 is an exploded perspective view of a primary portion of a haptic presentation apparatus according to a second embodiment of the present disclosure.

FIG. 7 is a top view of a haptic generation unit.

FIG. 8 is a top view of portions of a specification layer and the haptic generation unit.

FIG. 9 is a side view of the primary portion of the haptic presentation apparatus.

FIG. 10 schematically illustrates deformation of the haptic presentation apparatus.

FIG. 11 schematically illustrates deformation of the haptic presentation apparatus according to modifications.

FIG. 12 is a block diagram illustrating an example of a configuration of a vehicle.

FIG. 13 illustrates an example of regions of sensing.

### MODE(S) FOR CARRYING OUT THE INVENTION

Embodiments according to the present disclosure will now be described below with reference to the drawings.

### I. First Embodiment

### 1. Primary Portion of Haptic Presentation Apparatus

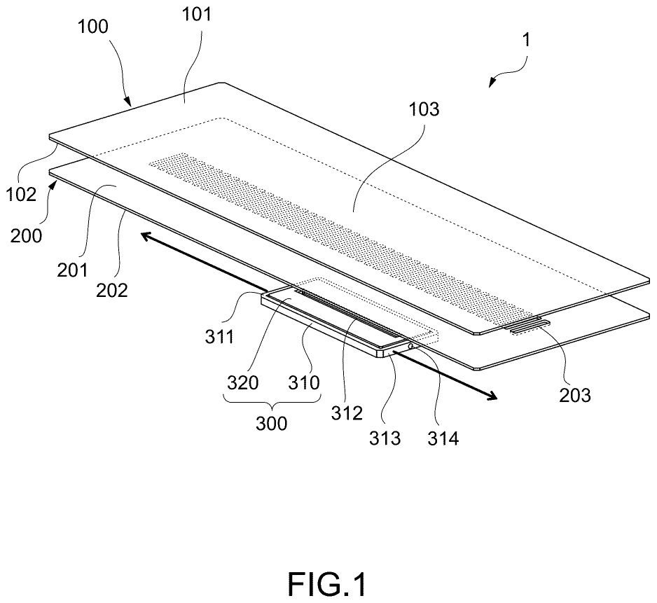

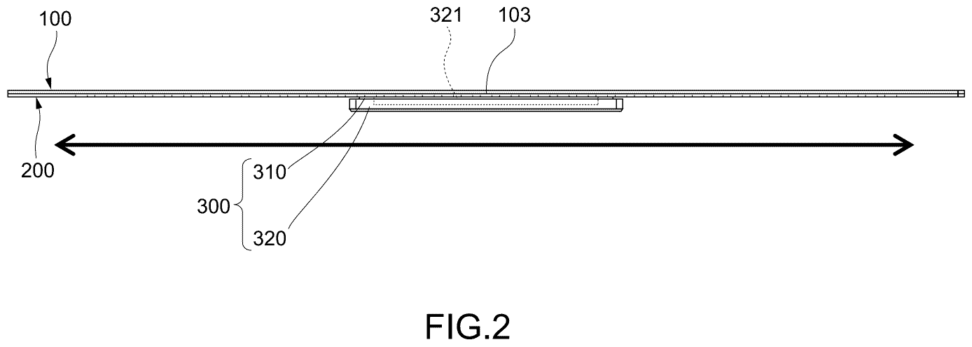

FIG. 1 is a perspective view of a primary portion of a haptic presentation apparatus according to a first embodiment of the present disclosure. FIG. 2 is a side view of the primary portion of the haptic presentation apparatus.

A haptic presentation apparatus 1 includes a flexible layer 100, a specification layer 200, and a haptic generation unit 300.

The flexible layer 100 includes a front surface 101 that is exposed to be touchable by a user. The flexible layer 100 forms a surface (a planar surface or a curved surface) of an object that is typically touched by a user with his/her finger. Examples of what is formed of the flexible layer 100 may include an inner wall surface of a house that serves as an in-house interface, and surfaces of various electronic apparatuses that serve as haptic displays. Further, the examples of what is formed of the flexible layer 100 in a vehicle may include an in-vehicle console that serves as an operation-related interface, an in-vehicle wheel that serves as the operation-related interface or a danger notification interface, and an interior wall of the vehicle that serves as the operation-related interface or the danger notification interface.

A user touches any portion of the front surface 101 of the flexible layer 100. A portion of the front surface 101 of the flexible layer 100 that is touched by the user is referred to as a touch portion 103. The touch portion 103 is not a specific portion of the flexible layer 100, but is a portion touched by the user with his/her finger discretionarily and is a different portion every time. The flexible layer 100 has flexibility and can be deformed. Examples of a material of the flexible layer 100 may include a silicone material and urethane. When, for example, the material of the flexible layer 100 is a silicone material, the flexible layer 100 may have a Shore A hardness of about 40 and a thickness of about 1 mm.

The specification layer 200 includes a front surface 201 that faces a back surface 102 of the flexible layer 100. Typically, the front surface 201 is brought into contact with the back surface 102 of the flexible layer 100. The specification layer 200 is not flexible and is typically not deformed when a user touches the flexible layer 100, which is different from the flexible layer 100. Examples of a material of the specification layer 200 may include a stainless material. When, for example, the material of the specification layer 200 is a stainless material, the specification layer 200 may have a thickness of about 1 mm. The specification layer 200 specifies a shape of the flexible layer 100 (a shape before deformation and a shape after the deformation). In other words, it can also be said that the specification layer 200 specifies a haptic sensation presented to a user who is in touch with the flexible layer 100.

The specification layer 200 includes through holes 203 that are each opened to face the back surface 102 of the flexible layer 100. The through hole 203 is opened to pass through the specification layer 200 from the front surface 201 to the back surface 202. In this example, each through hole 203 has, in a plan view, an elongated and substantially rectangular shape in the form of a slit. Each through hole 203 has a width of, for example, about 4 mm (a length of a short side of the substantially rectangular shape). The through holes 203 are arranged parallel to each other in a line with a constant pitch (of, for example, about 6 mm) in a width direction. The shape of each through hole 203 in the plan view and the arrangement of the through holes 203 can be selected discretionarily in order to obtain a shape of the flexible layer 100 after deformation, that is, a shape of the flexible layer 100 for providing a haptic sensation presented to a user. In other words, the shape of the flexible layer 100 after deformation, that is, a haptic sensation presented to a user is specified by the shape of each through hole 203 in the plan view and the arrangement of the through holes 203.

The haptic generation unit 300 faces a back surface 202 of the specification layer 200. The haptic generation unit 300 is moved to a position that corresponds to (typically, faces) the touch portion 103 included in the flexible layer 100 and touched by a user, and deforms the touch portion 103 of the flexible layer 100. The haptic generation unit 300 includes a body 310 and an annular member 320.

The body 310 includes a front surface 311 that faces the back surface 202 of the specification layer 200. Typically, when the specification layer 200 is planar, the front surface 311 of the body 310 is also planar. There is a space inside the body 310, and the space is an internal spatial room (not illustrated). A layer-side opening 312 is opened in the front surface 311 of the body 310. The layer-side opening 312 communicates with the internal spatial room of the body 310. A pump-side opening 314 is opened in a surface (a lateral surface 313 in this example) of the body 310 that is other than the front surface 311. The pump-side opening 314 communicates with the internal spatial room of the body 310. In other words, the pump-side opening 314 communicates with the layer-side opening 312 through the internal spatial room. Fluid can move from the layer-side opening 312 to the pump-side opening 314 through the internal spatial room. In other words, fluid can move from the pump-side opening 314 to the layer-side opening 312 through the internal spatial room. The fluid is gas or liquid and is typically air.

The annular member 320 is provided to the front surface 311 of the body 310, and is annular like, for example, an O-ring. The annular member 320 is arranged to surround the layer-side opening 312 of the front surface 311. The annular member 320 is made of a material such as rubber that provides airtightness. The annular member 320 faces the back surface 202 of the specification layer 200. The annular member 320 is in close contact with the back surface 202 of the specification layer 200, and a fluid room 321 that is a space partitioned off by the back surface 202 of the specification layer 200 and an inner side of the annular member 320 is made air-and liquid-tight.

The haptic generation unit 300 is moved by a movement mechanism (not illustrated) on the side of the back surface 202 of the specification layer 200. For example, the haptic generation unit 300 is movable back and forth one axially (arrows illustrated in FIGS. 1 and 2), back and forth two axially, or discretionarily in a plane parallel to the back surface 202 of the specification layer 200. The haptic generation unit 300 may be movable in a direction (a thickness direction of each of the flexible layer 100 and the specification layer 200) orthogonal to the back surface 202 of the specification layer 200. When each of the flexible layer 100 and the specification layer 200 is not planar but three-dimensional, the haptic generation unit 300 is also moved three-dimensionally to be in close contact with the back surface 202 of the specification layer 200. Examples of the movement mechanism of the haptic generation unit 300 may include one-, two-, and three-axis stages using, for example, ball screws or pulley, as well as a linear transport stage of, for example, a magnetic-levitation type.

### 2. Behavior of Haptic Presentation Apparatus

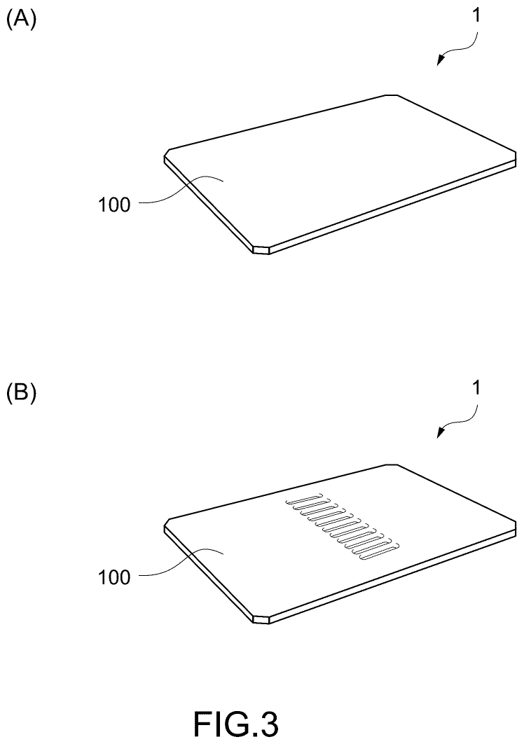

FIG. 3 schematically illustrates deformation of the haptic presentation apparatus.

The touch portion 103 included in the front surface 101 of the flexible layer 100 and touched by a user is detected by a sensor 401 (described later). Then, the haptic generation unit 300 is moved to a position that corresponds to the touch portion 103 included in the flexible layer 100 and touched by the user. The annular member 320 of the haptic generation unit 300 faces the back surface 202 of the specification layer 200 in contact with the back surface 202 or through a very small space. At this point, the annular member 320 may be in close contact with the back surface 202 of the specification layer 200, and the fluid room 321 partitioned off by the back surface 202 of the specification layer 200 and the inner side of the annular member 320 may be made air-and liquid-tight, or the state does not necessarily have to be so. The haptic generation unit 300 may be moved upward by the movement mechanism toward the specification layer 200 such that the annular member 320 of the haptic generation unit 300 gets closer to the back surface 202 of the specification layer 200, and the air-and liquid-tight state may be created more positively.

Fluid (air) is sucked in from the layer-side opening 312 of the body 310. The fluid room 321 partitioned off by the back surface 202 of the specification layer 200 and the inner side of the annular member 320 is made air-and liquid-tight. Specifically, the fluid (the air) in the fluid room 321 passes through the layer-side opening 312 and the internal spatial room to be discharged from the pump-side opening 314. Then, the fluid (the air) in the fluid room 321 exhibits a negative pressure (for example, −50 KPa), and the flexible layer 100 sticks to the specification layer 200. Portions of the flexible layer 100 that respectively face the through holes 203 of the specification layer 200 are pulled into the respective through holes 203. As a result, a region that includes the touch portion 103 of the front surface 101 of the flexible layer 100, that is, specifically a region, in the flexible layer 100, that is specified by a shape of an inner periphery of the annular member 320 is deformed to have an uneven surface. Due to a change in frictional state, a user can haptically recognize that the touch portion 103 is deformed to have an uneven surface.

When the suction of the fluid is stopped and the pressure of the fluid (the air) in the fluid room 321 returns to an atmospheric pressure from the negative pressure, the portions of the flexible layer 100 that are pulled into the respective through holes 203 of the specification layer 200 exit the through holes 203, and the flexible layer 100 returns to its planar state. Note that the stop of the suction includes discharging fluid, and not sucking in or discharging the fluid.

Further, it is possible to vibrate the flexible layer 100 by repeatedly and continuously performing suction and stop of the suction alternately.

Note that specific examples of the materials of the flexible layer 100 and the specification layer 200 have been described above. However, those are merely examples. The above-described specific examples of the materials meet conditions that enable a user to perceive a planar surface (negative pressure is off=atmospheric pressure) and to perceive an uneven surface (negative pressure is on =−50 KPa). The examples of the materials of and the dimensional examples of the flexible layer 100 and the specification layer 200 may be changed due to an enhancement or declination in a performance of a drive source that causes fluid to be sucked and to exhibit a negative pressure.

### 3. Hardware Configuration of Haptic Presentation Apparatus

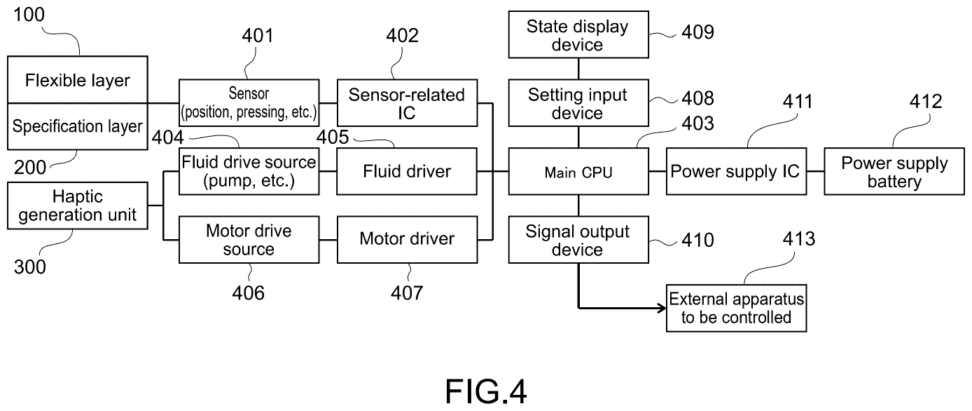

FIG. 4 illustrates a hardware configuration of the haptic presentation apparatus.

In addition to the flexible layer 100, the specification layer 200, and the haptic generation unit 300, the haptic presentation apparatus 1 further includes the sensor 401, a sensor-related circuit 402, a primary processor 403, a fluid drive source 404, a fluid driver 405, a motor drive source 406, a motor driver 407, a setting input device 408, a state display device 409, a signal output device 410, a power supply circuit 411, and a power supply battery 412. Sets of the fluid drive source 404, fluid driver 405, motor drive source 406, and motor driver 407 connected to the haptic generation unit 300 are arranged in parallel depending on the number of haptic generation units 300.

The sensor 401 detects, for example, a resistance value, capacitance, piezoelectricity, a fluid pressure, an amount of light received, and sound and may detect a combination thereof. The sensor 401 detects the touch portion 103 included in the front surface 101 of the flexible layer 100 and touched by a user. The sensor 401 may be formed integrally with the flexible layer 100. The sensor-related circuit 402 reports the touch portion 103 detected by the sensor 401 to the primary processor 403. In response to the report being made by the sensor-related circuit 402, the primary processor 403 controls the motor driver 407 and the fluid driver 405. The motor driver 407 is controlled by the primary processor 403 to drive the motor drive source 406 and to move the haptic generation unit 300 by use of the movement mechanism (not illustrated). The fluid driver 405 is controlled by the primary processor 403 to drive the fluid drive source 404 and to suck in and discharge fluid to deform the flexible layer 100. The fluid drive source 404 includes a pump that sucks in and discharges fluid (air), and is connected to the pump-side opening 314 of the haptic generation unit 300. The fluid drive source 404 sucks in fluid from and discharges fluid into the haptic generation unit 300 through the pump-side opening 314.

The signal output device 410 outputs, to an external control-target apparatus 413, a signal corresponding to an operation performed by a user on the touch portion 103. The setting input device 408 receives input performed by the user regarding settings of the haptic presentation apparatus 1. The state display device 409 displays the settings of the haptic presentation apparatus 1 to the user. The power supply circuit 411 supplies, for example, the primary processor 403 with power supply from the power supply battery 412. The power supply battery 412 may be an in-vehicle battery, a secondary battery or primary battery built in an electronic apparatus, or an in-house AC power supply.

### 4. Flow of Operation Performed by Haptic Presentation Apparatus

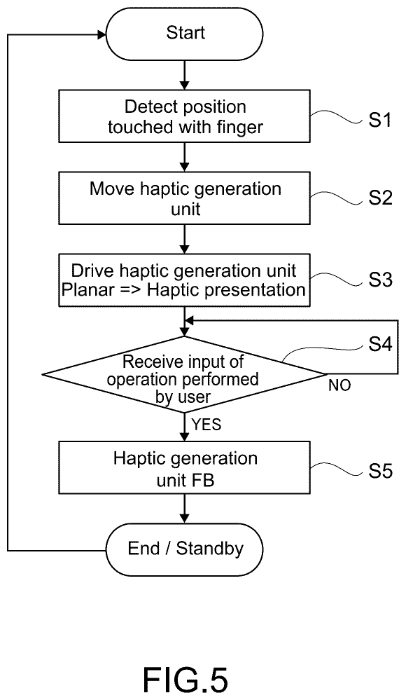

FIG. 5 is a flow of operation performed by the haptic presentation apparatus.

The sensor 401 is, for example, a pressure sensor, and detects the touch portion 103 included in the front surface 101 of the flexible layer 100 and touched by a user. The sensor-related circuit 402 reports the touch portion 103 detected by the sensor 401 to the primary processor 403 (Step S1). In response to the report being made by the sensor-related circuit 402, the primary processor 403 controls the motor driver 407 so that the motor drive source 406 is driven and the haptic generation unit 300 is moved by use of the movement mechanism (not illustrated) to a position that corresponds to (typically, faces) the touch portion 103 (Step S2). Specifically, when the haptic generation unit 300 moves to the position corresponding to the touch portion 103 included in the flexible layer 100 and touched by the user, a space inside of the annular member 320 faces the touch portion 103.

In response to the report being made by the sensor-related circuit 402, the primary processor 403 further controls the fluid driver 405 so that the fluid drive source 404 (a pump) is driven and the flexible layer 100 is deformed (Step S3). As a result, a partial region of the flexible layer 100 is deformed to have an uneven surface. Due to a change in frictional state, the user haptically recognizes that the touch portion 103 of the flexible layer 100 is deformed to have an uneven surface. Particularly in the case of being used by being mounted on a vehicle, there is no need to gaze at or give an awareness to a haptic presentation position. This results in securing safety. The user inputs an operation (such as pushdown, tap, or swiping) to the touch portion 103 of the flexible layer 100 after the deformation. The sensor-related circuit 402 reports, to the primary processor 403, the input of the operation performed by the user (Step S4).

The primary processor 403 controls the signal output device 410 so that a signal corresponding to the operation performed by the user on the touch portion 103 is output to the external apparatus 413 to be controlled. The primary processor 403 further controls the fluid driver 405 so that the fluid drive source 404 (the pump) is driven and the flexible layer 100 is further deformed, and gives back haptic feedback to the user (Step S5). The haptic feedback may be, for example, returning the flexible layer 100 to its planar state, or vibrating the flexible layer 100 by repeatedly and continuously performing suction and stop of the suction alternately.

### II. Second Embodiment

Hereinafter, descriptions of, for example, the structural elements and operations described above are omitted, and the description is made focused on, for example, a structural element and an operation that are different from those described above.

### 1. Primary Portion of Haptic Presentation Apparatus

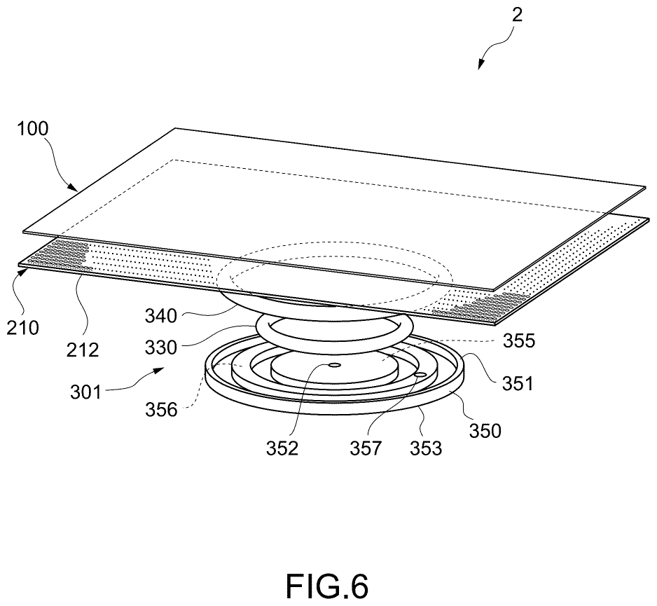

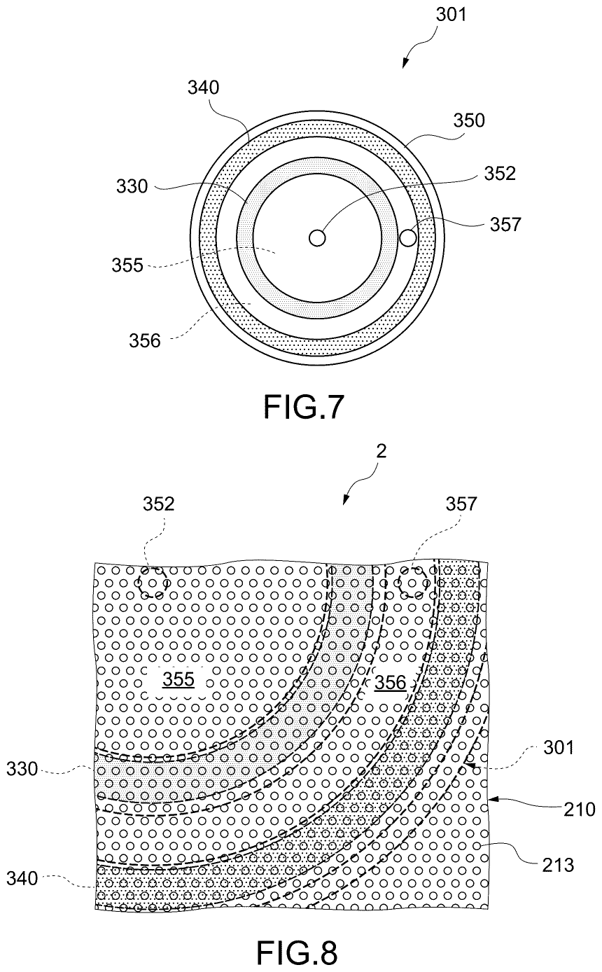

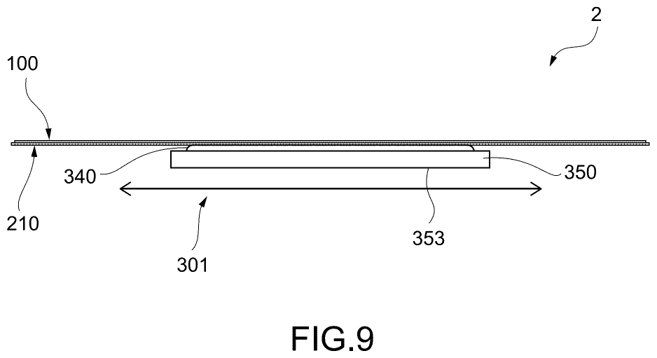

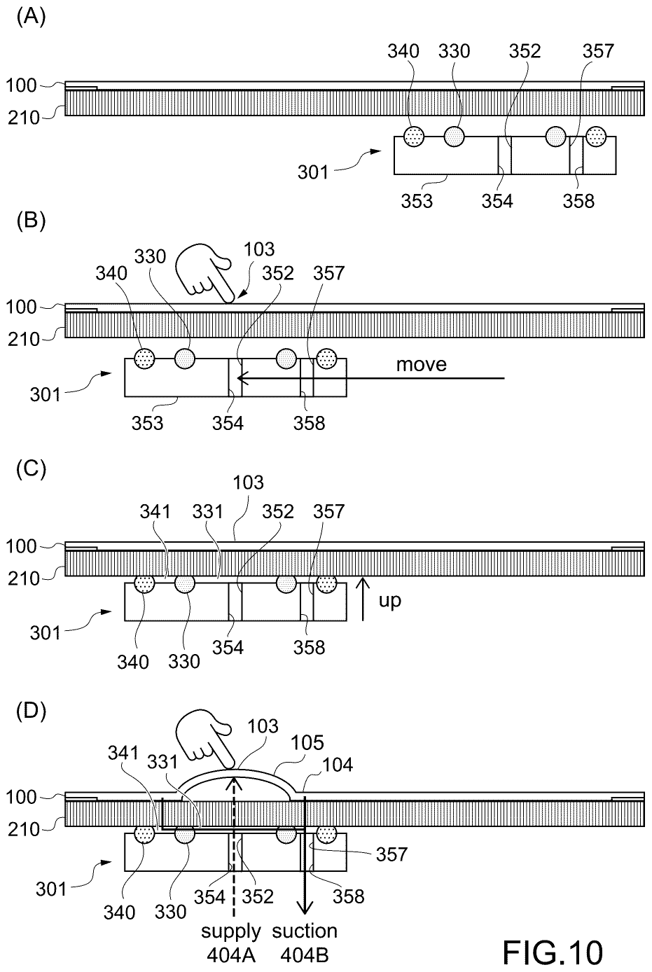

FIG. 6 is an exploded perspective view of a primary portion of a haptic presentation apparatus according to a second embodiment of the present disclosure. FIG. 7 is a top view of a haptic generation unit. FIG. 8 is a top view of portions of a specification layer and the haptic generation unit. FIG. 9 is a side view of the primary portion of the haptic presentation apparatus. FIG. 10 schematically illustrates deformation of the haptic presentation apparatus.

A haptic presentation apparatus 2 according to the second embodiment is different from the haptic presentation apparatus 1 according to the first embodiment in the specification layer 200 and the haptic generation unit 300.

A specification layer 210 includes through holes 213. In this example, each through hole 213 has a shape of a very small circle in a plan view. Each through hole 213 has a diameter of, for example, about a few millimeters. The through holes 213 are arranged two-dimensionally to be spaced equally with a constant pitch (of, for example, about a few millimeters). The specification layer 210 is what is called a perforated metal.

A haptic generation unit 301 includes a body 350, an inner annular member 330, and an outer annular member 340.

The body 350 includes a front surface 351 that faces a back surface 212 of the specification layer 210. The body 350 includes an inner spatial room 355 and an outer spatial room 356 that are internal spaces. The inner spatial room 355 is provided to a center portion of the body 350 in the plan view. The outer spatial room 356 is spaced from the inner spatial room 355 to surround the inner spatial room 355. Fluid (air) can flow through the inner spatial room 355, and fluid (air) can flow through the outer spatial room 356. The inner spatial room 355 and the outer spatial room 356 are separate from each other and independent of each other, which results in fluid being unable to move between the inner spatial room 355 and the outer spatial room 356.

An inner layer-side opening 352 is opened in the front surface 351 of the inner spatial room 355 of the body 350. The inner layer-side opening 352 communicates with the inner spatial room 355 of the body 350. An inner pump-side opening 354 is opened in a surface (a bottom surface 353 in this example) of the inner spatial room 355 of the body 350 that is other than the front surface 351. The inner pump-side opening 354 communicates with the inner spatial room 355 of the body 350. In other words, the inner pump-side opening 354 communicates with the inner layer-side opening 352 through the inner spatial room 355. Fluid can move from the inner layer-side opening 352 to the inner pump-side opening 354 through the inner spatial room 355. In other words, fluid can move from the inner pump-side opening 354 to the inner layer-side opening 352 through the inner spatial room 355.

An outer layer-side opening 357 is opened in the front surface 351 of the outer spatial room 356 of the body 350. The outer layer-side opening 357 communicates with the outer spatial room 356 of the body 350. An outer pump-side opening 358 is opened in a surface (the bottom surface 353 in this example) of the outer spatial room 356 of the body 350 that is other than the front surface 351. The outer pump-side opening 358 communicates with the outer spatial room 356 of the body 350. In other words, the outer pump-side opening 358 communicates with the outer layer-side opening 357 through the outer spatial room 356. Fluid can move from the outer layer-side opening 357 to the outer pump-side opening 358 through the outer spatial room 356. In other words, fluid can move from the outer pump-side opening 358 to the outer layer-side opening 357 through the outer spatial room 356.

The inner pump-side opening 354 and the outer pump-side opening 358 are respectively connected to different fluid drive sources 404A and 404B independent of each other. The fluid drive sources 404A and 404B respectively include pumps that suck in and discharge fluid (air) independently of each other. The fluid drive source 404A sucks in fluid from and discharges fluid into the inner spatial room 355 through the inner pump-side opening 354. The fluid drive source 404B sucks in fluid from and discharges fluid into the outer spatial room 356 through the outer pump-side opening 358.

The inner annular member 330 is annular like, for example, an O-ring and arranged to surround the inner spatial room 355 provided with the inner layer-side opening 352 of the body 350. A front surface of the inner annular member 330 is situated higher than the front surface 351 of the inner spatial room 355 and the outer spatial room 356, that is, the front surface of the inner annular member 330 is situated closer to the specification layer 210 than the front surface 351. The inner annular member 330 is made of a material such as rubber that provides airtightness. The inner annular member 330 faces the back surface 212 of the specification layer 210. The inner annular member 330 is in close contact with the back surface 212 of the specification layer 210, and an inner fluid room 331 that is a space partitioned off by the back surface 212 of the specification layer 210 and an inner side of the inner annular member 330 is made air-and liquid-tight.

The outer annular member 340 is annular like, for example, an O-ring and arranged to surround the outer spatial room 356 provided with the outer layer-side opening 357 of the body 350 and the inner annular member 330 situated more inward than the outer spatial room 356. A front surface of the outer annular member 340 is situated higher than the front surface 351 of the inner spatial room 355 and the outer spatial room 356, that is, the front surface of the outer annular member 340 is situated closer to the specification layer 210 than the front surface 351. The front surface of the outer annular member 340 and the front surface of the inner annular member 330 are situated at equal heights. The outer annular member 340 is made of a material such as rubber that provides airtightness. The outer annular member 340 faces the back surface 212 of the specification layer 210. The outer annular member 340 is in close contact with the back surface 212 of the specification layer 210, and an outer fluid room 341 that is a space partitioned off by the back surface 212 of the specification layer 210, an outer side of the inner annular member 330, and an inner side of the outer annular member 340 is made air-and liquid-tight. The outer fluid room 341 and the inner fluid room 331 are completely separated by the inner annular member 330.

### 2. Behavior of Haptic Presentation Apparatus

Deformation of the haptic presentation apparatus is described with reference to FIG. 10.

The touch portion 103 included in the front surface 101 of the flexible layer 100 in a standby state in (A) and touched by a user is detected by the sensor 401. Then, the haptic generation unit 301 is moved to a position that corresponds to the touch portion 103 included in the flexible layer 100 and touched by the user, as illustrated in (B). The inner annular member 330 and outer annular member 340 of the haptic generation unit 301 face the back surface 212 of the specification layer 210 in contact with the back surface 212 or through a very small space, as illustrated in (C). At this point, the inner annular member 330 and the outer annular member 340 may be in close contact with the back surface 212 of the specification layer 210, and the inner fluid room 331 and the outer fluid room 341 may be made air-and liquid-tight, or the state does not necessarily have to be so. The haptic generation unit 301 may be moved upward by the movement mechanism toward the specification layer 210 such that the inner annular member 330 and outer annular member 340 of the haptic generation unit 301 get closer to the back surface 212 of the specification layer 210.

As illustrate in (D), when fluid (air) is sucked in from the outer layer-side opening 357 of the body 350, the outer fluid room 341 is made air-and liquid-tight. Specifically, the fluid (the air) in the outer fluid room 341 passes through the outer layer-side opening 357 and the outer spatial room 356 to be discharged from the outer pump-side opening 358. Then, the fluid (the air) in the outer fluid room 341 exhibits a negative pressure (for example, −50 KPa), and the flexible layer 100 sticks to the specification layer 210. Portions of the flexible layer 100 that respectively face the through holes 213 of the specification layer 210 are pulled into the respective through holes 213. As a result, an annular region 104 that is situated around the touch portion 103 of the front surface 101 of the flexible layer 100, that is, specifically the annular region 104 included in the flexible layer 100 and specified by a shape of an outer periphery of the inner annular member 330 and a shape of an inner periphery of the outer annular member 340 is deformed to have an uneven surface. Note that, depending on a combination of a fluid (air) pressure in the outer fluid room 341, materials of the flexible layer 100 and the specification layer 210, and dimensions of the flexible layer 100 and the specification layer 210, the annular region 104 included in the flexible layer 100 and specified by the shape of the outer periphery of the inner annular member 330 and the shape of the inner periphery of the outer annular member 340 can remain planar without being deformed to have an uneven surface.

On the other hand, fluid (air) is discharged into the inner fluid room 331 from the inner layer-side opening 352 of the body 350. Specifically, the fluid is discharged into the inner fluid room 331 from the inner pump-side opening 354 through the inner spatial room 355 and the inner layer-side opening 352. Then, the fluid (air) in the inner fluid room 331 exhibits a positive pressure. As a result, a region that includes the touch portion 103 of the front surface 101 of the flexible layer 100, that is, specifically a deformation region 105 that is situated inside of the annular region 104 sticking to the specification layer 210 is expanded. The user can haptically recognize that the touch portion 103 is deformed to have a convex surface.

When the discharge of the fluid into the inner fluid room 331 is stopped and the pressure of the fluid (air) in the inner fluid room 331 returns to the atmospheric pressure from the positive pressure, the expanded portion of the flexible layer 100 returns to its planar state.

When, conversely, fluid (air) is sucked in from the inner layer-side opening 352 of the body 350, the inner fluid room 331 is made air-and liquid-tight. Specifically, the fluid (air) in the inner fluid room 331 is discharged from the inner pump-side opening 354 through the inner layer-side opening 352 and the inner spatial room 355. Then, the fluid (air) in the inner fluid room 331 exhibits a negative pressure (for example, −50 KPa), and the flexible layer 100 sticks to the specification layer 210. Portions of the flexible layer 100 that respectively face the through holes 213 of the specification layer 210 are pulled into the respective through holes 213. As a result, the region including the touch portion 103 of the front surface 101 of the flexible layer 100, that is, specifically the deformation region 105 situated inside of the annular region 104 sticking to the specification layer 210 is deformed to have an uneven surface (a porous surface). Due to a change in frictional state, a user can haptically recognize that the touch portion 103 is deformed to have an uneven surface (a porous surface).

When the suction of the fluid from the inner fluid room 331 is stopped and the pressure of the fluid (the air) in the fluid room 331 returns to the atmospheric pressure from the negative pressure, the portions of the flexible layer 100 that are pulled into the respective through holes 203 of the specification layer 210 exit the through holes 203, and the flexible layer 100 returns to its planar state.

Further, it is possible to vibrate the flexible layer 100 by repeatedly and continuously performing suction from the inner fluid room 331 and stop of the suction alternately.

In the present embodiment, the annular region 104 corresponding to a contour of the deformation region 105 of the flexible layer 100 is specified by fluid being sucked in from the outer fluid room 341. On the other hand, the deformation region 105 can be deformed to have a convex surface by fluid being discharged into the inner fluid room 331, and the deformation region 105 can be deformed to have an uneven surface (a porous surface) by fluid being sucked in from the inner fluid room 331. In other words, different kinds of haptic sensation can be presented to a user by the in-common touch portion 103 being deformed into two different kinds of shapes. Further, a periodically changed haptic sensation can be chronologically presented to a user by the surface of the deformation region 105 of the flexible layer 100 being periodically changed between a convex surface and an uneven surface.

### III. Modifications

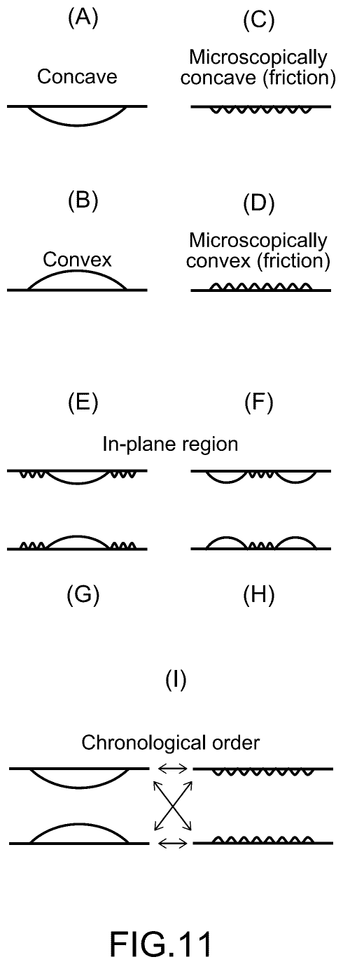

FIG. 11 schematically illustrates deformation of the haptic presentation apparatus according to modifications.

In the second embodiment, the through holes 213 having very small sizes are provided to the specification layer 210 correspondingly to the deformation region 105 of the flexible layer 100. On the other hand, one through hole having a size corresponding to a fingertip of a user (for example, having a diameter of about a few centimeters) may be provided to the specification layer 210 correspondingly to the deformation region 105 of the flexible layer 100. When fluid is sucked in, the flexible layer 100 is pulled into the through hole, and a concave surface having the size of the through hole is formed, as illustrated in (A). On the other hand, when fluid is discharged, the deformation region 105 specified by the annular region 104 of the flexible layer 100 is deformed to have a convex surface, as in the second embodiment, as illustrated in (B).

As in the second embodiment, the through holes 213 having very small sizes are provided to the specification layer 210 correspondingly to the deformation region 105 of the flexible layer 100. The haptic generation unit 301 can independently and individually discharge fluid into and suck in fluid from the through holes 213. When fluid is sucked in, portions of the flexible layer 100 are pulled into the through holes having very small sizes, and an uneven surface (a porous surface) is formed, as illustrated in (C). On the other hand, when fluid is discharged, an uneven surface in which the portions of the flexible layer 100 finely bulge out (protrude) from the through holes having very small sizes, is formed, as illustrated in (D).

The specification layer 210 may include through holes having different sizes. The haptic generation unit 301 may suck in fluid from and/or discharge fluid into the through holes having different sizes to present different kinds of haptic sensation. For example, a relatively large through hole having a size corresponding to a fingertip of a user (for example, having a diameter of about a few centimeters), and a group of very small through holes periodically arranged to surround the relatively larger through hole may be arranged alternately. Fluid is sucked in from one large through hole so that the flexible layer 100 is deformed to have the concave surface illustrated in (A), and the fluid is discharged into the one large through hole so that the flexible layer 100 is deformed to have the convex surface illustrated in (B). Fluid is sucked in from a group of very small through holes so that the flexible layer 100 is deformed to have the uneven surface (the porous surface) illustrated in (C), and the fluid is discharged into the group of very small through holes so that the flexible layer 100 is deformed to have the protruding uneven surface illustrated in (D).

As illustrated in (E), (F), (G), and (H), deformation is performed by sucking in fluid from and discharging the fluid into at least one relatively large through hole and at least one group of very small through holes that are adjacent to each other. This makes it possible to present a combination of different kinds of haptic sensation to a user. Further, discharge of fluid into and suction of the fluid from each of at least one relatively large through hole and at least one group of very small through holes are repeated to change the deformation periodically. This makes it possible to chronologically present a periodically changed haptic sensation to a user, as illustrated in (I).

### IV. Summary

Typically, a presentation position on a haptic device that includes a planar surface is specified. Thus, it is necessary for a user to obtain a key to know the haptic presentation position by visual confirmation. It is desirable, from the viewpoint of safety, that a user avoid shifting his/her gaze particularly when a haptic device used by being mounted on a vehicle is used.

A touchscreen is an example of the haptic presentation apparatus including a normally planar surface. There is a need to visually confirm a position, on the touchscreen, that is to be touched, and it is not desirable, from the viewpoint of safety, that gaze be shifted. When a state is changed from being planar for haptic presentation, for example, upward and downward driving performed by a motor using mechanical coma is conceivable. In this case, there is a need to provide driving devices to all of regions in which haptic presentation is performed, and to perform individual driving. This results in complicated structure.

On the other hand, in the present embodiment, the haptic presentation apparatus includes a flexible layer that includes a normally planar surface and that presents a change in friction or shape. A lower layer of the flexible layer includes a specification layer that provides desired haptic effects. The specification layer includes a normally planar surface, any position touched by a user is detected upon using the haptic presentation apparatus, the haptic generation unit is moved to the position, and fluid is sucked in and discharged to generate haptic sensation.

When haptic presentation is performed at a specified position, a haptic presentation position is specified literally. Thus, there is a need to give a user's awareness to the haptic presentation position. On the other hand, the present disclosure makes it possible to perform haptic presentation to any position touched by a user. Particularly in the case of being used by being mounted on a vehicle, there is no need to gaze at or give an awareness to a haptic presentation position. This results in securing safety.

The haptic generation unit is moved to any position touched by a user and driving is performed at the position. This results in there being no need to provide haptic generation units to all of regions on the surface. This results in obtaining a simple structure and thus in contributing toward reducing costs. Particularly when fluid is a drive source, remote operation or driving performed at any position (driving can be performed according to the formation of a flow path) is suitable. When the air in the outside world is a drive source, placement can be performed regardless of location. Further, a surface shape is changed due to fluid being sucked in or discharged. This results in obtaining a simple structure and thus in contributing toward reducing costs. Each of a shape change that provides haptic presentation, and a frictional change obtained by microscopically viewing the shape change is a change in state between a concave surface and a convex surface, and a negative-pressure fluid and a positive-pressure fluid are suitably drive sources.

According to the present embodiment, there is no need to obtain a key to know a haptic presentation position by visual confirmation, and this makes it possible to perform, due to a change in friction or shape, haptic presentation at any position touched by a user. The haptic presentation apparatus provides an interface that could contribute toward improving the landscape due to normally planar surface. This makes it possible to ensure confident operation while securing safety, and to obtain a value for customers in improving the landscape when the haptic presentation apparatus is not in use.

### V. Example of Configuration of Vehicle

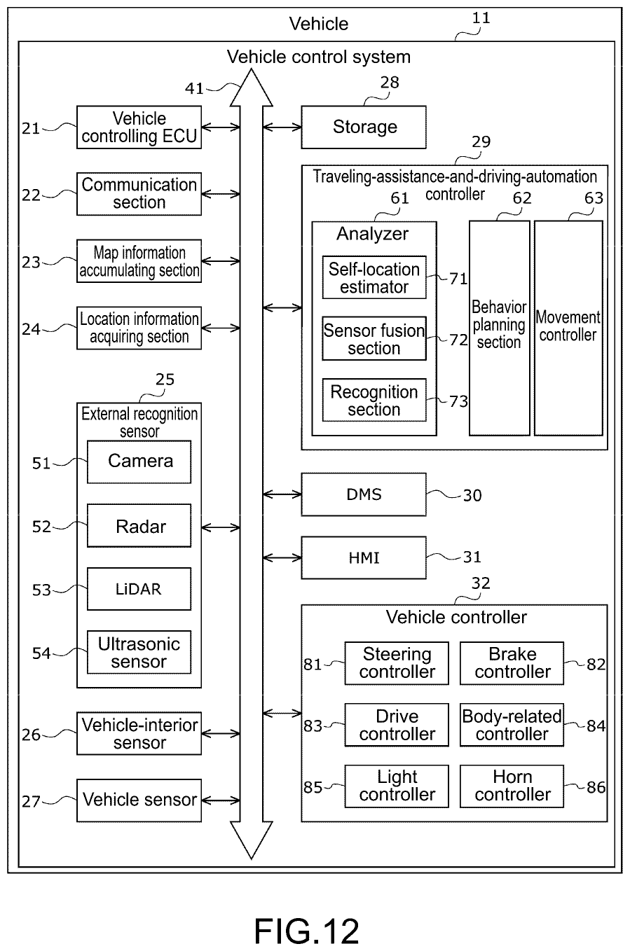

FIG. 12 is a block diagram illustrating an example of a configuration of a vehicle to which the present technology is applied.

A vehicle control system 11 is provided to the vehicle, and performs a process related to driving automation for the vehicle. The driving automation includes driving automation from Level 1 to Level 5, as well as remote driving of the vehicle and remote assistance for the vehicle that are performed by a remote driver.

The vehicle control system 11 includes a vehicle controlling electronic control unit (ECU) 21, a communication section 22, a map information accumulating section 23, a location information acquiring section 24, an external recognition sensor 25, a vehicle-interior sensor 26, a vehicle sensor 27, a storage 28, a driving automation controller 29, a driver monitoring system (DMS) 30, a human machine interface (HMI) 31, and a vehicle controller 32.

The vehicle controlling ECU 21, the communication section 22, the map information accumulating section 23, the location information acquiring section 24, the external recognition sensor 25, the vehicle-interior sensor 26, the vehicle sensor 27, the storage 28, the driving automation controller 29, the DMS 30, the HMI 31, and the vehicle controller 32 are communicably connected to each other through a communication network 41. For example, the communication network 41 includes, for example, an in-vehicle communication network or bus that is compliant with digital bidirectional communication standards, where examples of the communication network 41 include a controller area network (CAN), a local interconnect network (LIN), a local area network (LAN), FlexRay (registered trademark), and Ethernet (registered trademark). The examples of the communication network 41 may be selectively used depending on the type of data to be transmitted. For example, CAN may be applied to data related to vehicle control, and Ethernet may be applied to large volumes of data. Note that structural elements of the vehicle control system 11 may be directly connected to each other without using the communication network 41, but using wireless communication, such as near field communication (NFC) or Bluetooth (registered trademark), that is provided on the assumption of communication at a relatively short distance.

Note that the description of the communication network 41 will be omitted below when the respective structural elements of the vehicle control system 11 communicate with each other through the communication network 41. For example, when the vehicle controlling ECU 21 and the communication section 22 communicate with each other through the communication network 41, it will be simply stated that the vehicle controlling ECU 21 and the communication section 22 communicate with each other.

For example, the vehicle controlling ECU 21 includes various processors such as a central processing unit (CPU) and a microprocessing unit (MPU). The vehicle controlling ECU 21 controls all of or a portion of functions of the vehicle control system 11.

The communication section 22 communicates with various vehicle-interior apparatuses, various vehicle-exterior apparatuses, other vehicles, servers, base stations, and the like, and performs transmission and reception of various types of data. Here, the communication section 22 can perform communication using a plurality of communication approaches.

A vehicle-exterior communication that can be performed by the communication section 22 is schematically described. For example, the communication section 22 communicates with, for example, a server (hereinafter referred to as an external server) situated in an external network through a base station or an access point, using a wireless communication approach such as the 5th generation mobile communication system (5G), long term evolution (LTE), or dedicated short range communications (DSRC). Examples of the external network with which the communication section 22 communicates include the Internet, a cloud network, or a carrier-specific network. The approach of communication performed by the communication section 22 with the external network is not particularly limited, and any wireless communication approach that enables digital bidirectional communication with a certain distance at a certain communication speed may be adopted as the communication approach, the certain distance being greater than or equal to a specified distance, the certain communication speed being greater than or equal to a specified communication speed.

Further, for example, the communication section 22 can communicate with a terminal situated near the vehicle, using a peer-to-peer (P2P) technology. Examples of the terminal situated near the vehicle include a terminal that is attached to a mobile object such as a pedestrian or a bicycle that moves at a relatively slow speed, a terminal placed at a fixed location in, for example, a store, and a machine-type communication (MTC) terminal. Furthermore, the communication section 22 can also perform V2X communication. The V2X communication refers to communication between the vehicle and something, such as vehicle-to-vehicle communication with another vehicle, vehicle-to-infrastructure communication with, for example, a roadside unit, vehicle-to-home communication with a home, and vehicle-to-pedestrian communication with, for example, a terminal of a pedestrian.

For example, the communication section 22 can receive, from the outside, a program used to update software used to control an operation of the vehicle control system 11 (over the air). Further, the communication section 22 can receive, from the outside, map information, traffic information, information regarding surroundings of the vehicle, and the like. Furthermore, for example, the communication section 22 can transmit, to the outside, information regarding the vehicle, and the information regarding surroundings of the vehicle. Examples of the information regarding the vehicle that is transmitted to the outside by the communication section 22 include data indicating a state of the vehicle, and a result of recognition performed by a recognition section 73. Further, for example, the communication section 22 performs communication associated with a vehicle emergency alerting system such as eCall.

For example, the communication section 22 receives an electromagnetic wave transmitted by the Vehicle Information and Communication System (VICS) (registered trademark) using, for example, a radio wave beacon, an optical beacon, and FM multiplex broadcasting.

A vehicle-interior communication that can be performed by the communication section 22 is schematically described. For example, the communication section 22 can communicate with each vehicle-interior apparatus wirelessly. The communication section 22 can communicate with a vehicle-interior apparatus wirelessly using a communication approach that makes it possible to perform digital bidirectional communication wirelessly at a certain communication speed that is greater than or equal to a specified communication speed, where examples of the communication approach include a wireless LAN, Bluetooth, NFC, and a wireless USB (WUSB). Without being limited thereto, the communication section 22 can also communicate with each vehicle-interior apparatus by wire. For example, the communication section 22 can communicate with a vehicle-interior apparatus by wire through a cable that is connected to a connection terminal (not illustrated). The communication section 22 can communicate with a vehicle-interior apparatus by wire using a communication approach that makes it possible to perform digital bidirectional communication by wire at a certain communication speed that is greater than or equal to a specified communication speed, where examples of the communication approach include a universal serial bus (USB), a high-definition multimedia interface (HDMI) (registered trademark), and a mobile high-definition link (MHL).

Here, the vehicle-interior apparatus refers to, for example, an apparatus that is not connected to the communication network 41 in the vehicle. For example, a mobile apparatus or a wearable apparatus of a person such as a driver in the vehicle, and an information apparatus that is brought in the vehicle to be temporarily placed in the vehicle are assumed to be the vehicle-interior apparatuses.

The map information accumulating section 23 accumulates therein one of or both a map acquired from the outside and a map created by the vehicle. For example, the map information accumulating section 23 accumulates therein, for example, a three-dimensional high-precision map, and a global map that is less precise and that covers a wider area than the high-precision map.

Examples of the high-precision map include a dynamic map, a point cloud map, and a vector map. For example, the dynamic map is a map that includes four layers of pieces of information that are dynamic information, semi-dynamic information, semi-static information, and static information, and the dynamic map is provided to the vehicle by, for example, an external server. The point cloud map is a map that includes point cloud (group-of-points data). For example, the vector map is a map that is adapted to driving automation by traffic information or the like such as locations of lanes and traffic lights being plotted on the point cloud map.

The point cloud map and the vector map may be provided by, for example, an external server. Alternatively, on the basis of results of sensing performed by, for example, a camera 51, a radar 52, and LiDAR 53, the point cloud map and the vector map may be created by the vehicle as maps to be matched to a local map described later, and may be accumulated in the map information accumulating section 23. Further, for example, map data of several hundred meters square with respect to a planned route on which the vehicle is going to travel is acquired from, for example, an external server when the high-precision map is provided by, for example, the external server, in order to reduce the amount of communication.

The location information acquiring section 24 receives a global navigation satellite system (GNSS) signal from a GNSS satellite, and acquires location information regarding a location of the vehicle. The acquired location information is supplied to the driving automation controller 29. Note that the acquisition of location information is not limited to the approach using a GNSS signal, and the location information acquiring section 24 may acquire the location information using, for example, a beacon.

The external recognition sensor 25 includes various sensors used to recognize a state outside of the vehicle, and supplies the structural elements of the vehicle control system 11 with pieces of sensor data from the respective sensors. The external recognition sensor 25 may include any type of sensor and any number of sensors.

For example, the external recognition sensor 25 includes the camera 51, the radar 52, the LiDAR (light detection and ranging, laser imaging detection and ranging) 53, and an ultrasonic sensor 54. Without being limited thereto, the external recognition sensor 25 may include at least one type of sensor from among the camera 51, the radar 52, the LiDAR 53, and the ultrasonic sensor 54. Any numbers of cameras 51, radars 52, LiDAR 53, and ultrasonic sensors 54 that can be actually placed in the vehicle may be acceptable. Further, the type of sensor included in the external recognition sensor 25 is not limited to this example, and the external recognition sensor 25 may include another type of sensor. An example of a region of sensing performed by each sensor of the external recognition sensor 25 will be described later.

Note that an image-capturing approach adopted by the camera 51 is not particularly limited. For example, cameras adopting various image-capturing approaches can be applied to the camera 51 as necessary, where examples of the cameras adopting various image-capturing approaches include a time-of-flight (ToF) camera, a stereo camera, a monocular camera, and an infrared camera that adopt image-capturing approaches that make it possible to perform distance measurement. Without being limited thereto, the camera 51 may be simply used to acquire a captured image regardless of distance measurement.

Further, for example, the external recognition sensor 25 may include an environment sensor used to detect an environment surrounding the vehicle. The environment sensor is a sensor used to detect an environment related to, for example, weather, a meteorological phenomenon, and brightness, and examples of the environment sensor may include various sensors such as a raindrop sensor, a fog sensor, a sunlight sensor, a snow sensor, and an illumination intensity sensor.

Further, for example, the external recognition sensor 25 includes a microphone used to, for example, detect sound around the vehicle and a location of a sound source.

The vehicle-interior sensor 26 includes various sensors used to detect information regarding the inside of a vehicle, and supplies the structural elements of the vehicle control system 11 with pieces of sensor data from the respective sensors. With respect to the types and the numbers of the various sensors, any types and any numbers of sensors that can be actually placed in the vehicle may be included in the vehicle-interior sensor 26.

For example, the vehicle-interior sensor 26 may include at least one type of sensor from among a camera, a radar, a seating sensor, a steering wheel sensor, a microphone, and a biological sensor. A camera, such as a time-of-flight (ToF) camera, a stereo camera, a monocular camera, or an infrared camera, that adopts an image-capturing approach that makes it possible to perform distance measurement may be used as the camera included in the vehicle-interior sensor 26. Without being limited thereto, the camera included in the vehicle-interior sensor 26 may be simply used to acquire a captured image regardless of distance measurement. The biological sensor included in the vehicle-interior sensor 26 is provided to, for example, a seat or a steering wheel, and detects various biological information regarding a user.

The vehicle sensor 27 includes various sensors used to detect a state of the vehicle, and supplies the structural elements of the vehicle control system 11 with pieces of sensor data from the respective sensors. With respect to the types and the numbers of the various sensors, any types and any numbers of sensors that can be actually placed in the vehicle may be included in the vehicle sensor 27.

For example, the vehicle sensor 27 includes a speed sensor, an acceleration sensor, an angular velocity sensor (a gyroscope), and an inertial measurement unit (IMU) obtained by combining these sensors. For example, the vehicle sensor 27 includes a steering angle sensor that detects a steering angle of a steering wheel, a yaw rate sensor, an accelerator sensor that detects an amount of operation of a gas pedal, and a brake sensor that detects an amount of operation of a brake pedal. For example, the vehicle sensor 27 includes a rotation sensor that detects a rotation speed of an engine or a motor, an air pressure sensor that detects a tire pressure, a slip ratio sensor that detects a slip ratio of a tire, and a wheel speed sensor that detects a rotation speed of a wheel. For example, the vehicle sensor 27 includes a battery sensor that detects a remaining battery life and a temperature of a battery, and an impact sensor that detects an impact imposed from the outside.

The storage 28 includes at least one of a nonvolatile storage medium or a volatile storage medium, and stores therein data and a program. The storage 28 is used as, for example, an electrically erasable programmable read only memory (EEPROM) or a random access memory (RAM), and a magnetic storage device, semiconductor storage device, optical storage device, or magneto-optical storage device that is a hard disc drive (HDD) can be applied as the storage medium. The storage 28 stores therein various programs and data used by the respective structural elements of the vehicle control system 11. For example, the storage 28 includes an event data recorder (EDR) or a data storage system for automated driving (DSSAD), and stores therein information regarding the vehicle before and after events such as accidents, and information acquired by the vehicle-interior sensor 26.

The driving automation controller 29 controls a driving automation function of the vehicle. For example, the driving automation controller 29 includes an analyzer 61, a behavior planning section 62, and a movement controller 63.

The analyzer 61 performs a process of analyzing states of the vehicle and its surroundings. The analyzer 61 includes a self-location estimator 71, a sensor fusion section 72, and the recognition section 73.

The self-location estimator 71 estimates a self-location of the vehicle on the basis of sensor data from the external recognition sensor 25 and a high-precision map accumulated in the map information accumulating section 23. For example, the self-location estimator 71 generates a local map on the basis of the sensor data from the external recognition sensor 25, and performs matching on the local map and the high-precision map to estimate the self-location of the vehicle. The location of the vehicle is estimated, with, for example, the middle of an axle for a rear pair of wheels being a reference.

Examples of the local map include a three-dimensional high-precision map created using a technology such as simultaneous localization and mapping (SLAM), and an occupancy grid map. Examples of the three-dimensional high-precision map include the point cloud map described above. The occupancy grid map is a map that indicates an occupation state of an object for each grid cell by dividing a three-or two-dimensional space around the vehicle into grid cells each having a specified size. For example, the occupation state of an object is represented by the presence or absence of the object or the probability of existence of the object. For example, the local map is also used to perform a process of detecting a state outside of the vehicle and a process of recognizing the outside state, the detection process and recognition process being performed by the recognition section 73.

Note that the self-location estimator 71 may estimate a self-location of the vehicle on the basis of location information acquired by the location information acquiring section 24 and sensor data from the vehicle sensor 27.

The sensor fusion section 72 performs a sensor-fusion process to obtain information by combining different types of pieces of sensor data of a plurality of pieces of sensor data (such as image data supplied by the camera 51 and sensor data supplied by the radar 52). Examples of a method for combining different types of pieces of sensor data include composite, integration, fusion, and association.

The recognition section 73 performs a detection process of detecting a state outside of the vehicle and a recognition process of recognizing the state outside of the vehicle.

For example, on the basis of, for example, information from the external recognition sensor 25, information from the self-location estimator 71, and information from the sensor fusion section 72, the recognition section 73 performs the detection process of detecting a state outside of the vehicle and the recognition process of recognizing the outside state.

Specifically, for example, the recognition section 73 performs, for example, a process of detecting an object situated around the vehicle and a process of recognizing the object. Examples of the process of detecting an object include a process of detecting, for example, the presence or absence of an object, a size of the object, a shape of the object, a location of the object, and movement of the object. Examples of the process of recognizing an object include a process of recognizing an attribute of an object such as the type of object, and a process of identifying a specific object. However, the detection process and the recognition process are not necessarily clearly distinguished from each other, and may overlap.

For example, the recognition section 73 clusters point cloud based on sensor data from, for example, the radar 52 or the LiDAR 53 into groups of points to detect an object situated around the vehicle. This results in detecting the presence or absence of an object situated around the vehicle, a size of the object, a shape of the object, and a location of the object.

For example, the recognition section 73 detects movement of an object situated around the vehicle by tracking movement of the group of points obtained by the clustering. This results in detecting a speed of and a traveling direction (a movement vector) of the object situated around the vehicle.

For example, the recognition section 73 detects or recognizes, for example, a vehicle, a person, a bicycle, an obstacle, a structure, a road, a traffic light, a traffic sign, and a road sign on the basis of image data supplied by the camera 51. Further, the recognition section 73 may perform a recognition process such as semantic segmentation to recognize the type of object situated around the vehicle.

For example, the recognition section 73 can perform a process of recognizing traffic rules around the vehicle on the basis of a map accumulated in the map information accumulating section 23, a result of estimation of a self-location that is performed by the self-location estimator 71, and a result of recognition of an object situated around the vehicle that is performed by the recognition section 73. As a result of the recognition process, the recognition section 73 can recognize, for example, a location and a state of a traffic light, details of a traffic sign and a road sign, details of traffic control, and a travelable lane.

For example, the recognition section 73 can perform a process of recognizing an environment surrounding the vehicle. Examples of a conceivable surrounding environment to be recognized by the recognition section 73 include weather, temperature, humidity, brightness, and a road surface condition.

The behavior planning section 62 creates a plan of the behavior of the vehicle. For example, the behavior planning section 62 performs a route planning process and a route following process to create the behavior plan.

Note that the route planning includes a global path planning and a local path planning. The global path planning includes a process of roughly planning a route from a start to a goal. The local path planning is also referred to as trajectory planning, and includes a process of creating a trajectory near the vehicle in consideration of motion characteristics of the vehicle, where the trajectory enables the vehicle to travel safely and smoothly on the planned route.

The route following is a process of planning movement to be performed to travel safely and accurately on a route planned by route planning within a time planned by the route planning. For example, the behavior planning section 62 can calculate a target speed for and a target angular velocity for the vehicle on the basis of a result of the route following process.

The movement controller 63 controls movement of the vehicle in order to implement the behavior plan created by the behavior planning section 62.

For example, the movement controller 63 controls a steering controller 81, a brake controller 82, and a drive controller 83 that are included in the vehicle controller 32 described later to control lateral and longitudinal motions of the vehicle such that the vehicle travels along a trajectory calculated using the trajectory planning. For example, the movement controller 63 performs control intended to implement driver assistance functions including collision avoidance or shock mitigation, traveling while maintaining a certain distance to a vehicle ahead, traveling while maintaining a vehicle speed, a warning of collision of the vehicle, and a warning of deviation of the vehicle from a lane, or performs control intended to achieve driving automation such as traveling without an operation performed by a driver or a remote driver.

The DMS 30 performs, for example, a process of authenticating a driver and a process of recognizing a state of the driver on the basis of, for example, sensor data from the vehicle-interior sensor 26 and input data input through the HMI 31 described later. Examples of a conceivable recognition-target state of a driver include a physical condition, a degree of arousal, a degree of concentration, a degree of fatigue, a direction of a line of sight, a degree of drunkenness, a driving operation, and a pose.

Note that the DMS 30 may perform a process of authenticating a user other than a driver and a process of recognizing a state of the user. Further, for example, the DMS 30 may perform a process of recognizing a vehicle-interior state on the basis of sensor data from the vehicle-interior sensor 26. Examples of a conceivable recognition-target vehicle-interior state include temperature, humidity, brightness, and odor.

Various pieces of data, instructions, and the like are input through the HMI 31, and the various data is presented to a user through the HMI 31.

The input of data through the HMI 31 is schematically described. The HMI 31 includes an input device used by a person to input data. The HMI 31 generates an input signal on the basis of data, an instruction, or the like input through the input device, and supplies the generated input signal to the respective structural elements of the vehicle control system 11. The HMI 31 includes, as the input devices, operators such as a touch panel, a button, a switch, and a lever. Without being limited thereto, the HMI 31 may further include an input device with which information can be input by a method, such as sound or a gesture, that is other than a manual operation. Further, the HMI 31 may use, as the input device, a remote-control apparatus using infrared light or radio waves, or an externally connected apparatus such as a mobile or wearable apparatus that supports an operation of the vehicle control system 11.

The data presentation performed by the HMI 31 is schematically described. The HMI 31 generates visual information, auditory information, and tactile information to be provided to a user or to the outside of the vehicle. Further, the HMI 31 performs output control to control, for example, output of the pieces of generated information, the details of the output, a timing of performing the output, and a method for performing the output. As the visual information, the HMI 31 generates and outputs, for example, an operation screen, display of a state of the vehicle, display of warning, an image such as a monitoring image indicating a state around the vehicle, and information provided by light. Further, as the auditory information, the HMI 31 generates and outputs information, such as voice guidance, a warning beep, and a warning message, that is provided by sound. Furthermore, as the tactile information, the HMI 31 generates and outputs information provided to a user through a tactile sense using, for example, force, oscillation, and movement.

For example, a display apparatus that displays thereon an image to present visual information, or a projector apparatus that projects an image to present visual information can be applied as an output device to which the HMI 31 outputs visual information. Note that, in addition to a display apparatus including a typical display, the display apparatus may be an apparatus, such as a head-up display, a transmissive display, or a wearable device including an augmented reality (AR) function, that displays visual information in a field of view of a user. Further, the HMI 31 can also use, as the output device to which visual information is output, a display device included in, for example, a navigation apparatus, an instrument panel, a camera monitoring system (CMS), an electronic mirror, or a lamp that is provided to the vehicle.

For example, an audio speaker, headphones, or earphones can be applied as the output device to which the HMI 31 outputs auditory information.

For example, a haptic element using a haptic technology can be applied as the output device to which the HMI 31 outputs tactile information. For example, the haptic element is provided to a portion of the vehicle, such as a steering wheel or a seat, with which a user comes into contact.

The vehicle controller 32 controls respective structural elements of the vehicle. The vehicle controller 32 includes the steering controller 81, the brake controller 82, the drive controller 83, a body-related controller 84, a light controller 85, and a horn controller 86.

For example, the steering controller 81 detects and controls a state of a steering system of the vehicle. The steering system includes, for example, a steering mechanism including, for example, a steering wheel, and electric power steering. The steering controller 81 includes, for example, a steering ECU that controls the steering system, and an actuator that drives the steering system.

For example, the brake controller 82 detects and controls a state of a brake system of the vehicle. The brake system includes, for example, a brake mechanism including, for example, a brake pedal, an antilock brake system (ABS), and a regenerative brake mechanism. The brake controller 82 includes, for example, a brake ECU that controls the brake system, and an actuator that drives the brake system.

For example, the drive controller 83 detects and controls a state of a drive system of the vehicle. The drive system includes, for example, a gas pedal, a driving force generating apparatus used to generate driving force for, for example, an internal-combustion engine or a driving motor, and a driving force transmitting mechanism used to transmit the driving force to wheels. The drive controller 83 includes, for example, a drive ECU that controls the drive system, and an actuator that drives the drive system.

For example, the body-related controller 84 detects and controls a state of a body-related system of the vehicle. The body-related system includes, for example, a keyless entry system, a smart key system, a power window apparatus, a power seat, an air conditioner, an airbag, a seat belt, and a shift lever. The body-related controller 84 includes, for example, a body-related ECU that controls the body-related system, and an actuator that drives the body-related system.

For example, the light controller 85 detects and controls states of various lights of the vehicle. Examples of a conceivable control-target light include a headlight, a backup light, a fog light, a turn signal, a stoplight, projection, and display of a bumper. The light controller 85 includes, for example, a light ECU that controls the lights, and an actuator that drives the lights.

For example, the horn controller 86 detects and controls a state of a car horn of the vehicle. The horn controller 86 includes, for example, a horn ECU that controls the car horn, and an actuator that drives the car horn.

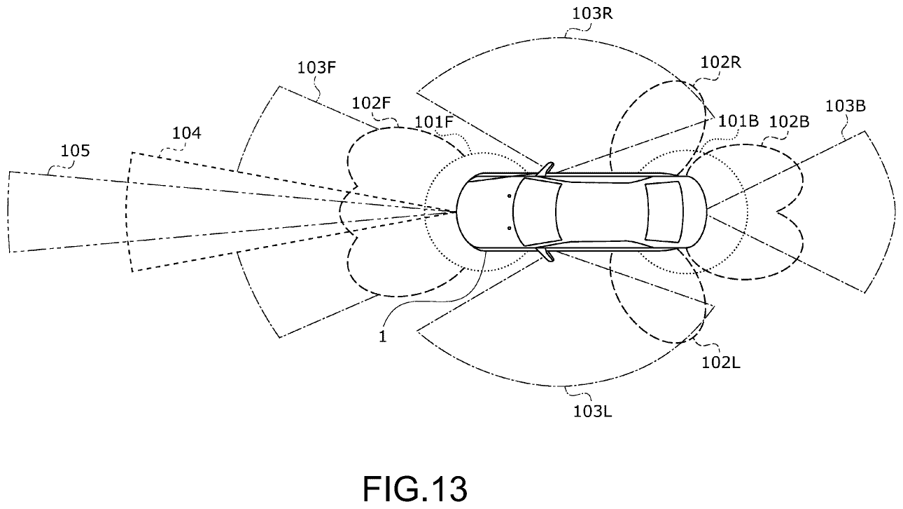

FIG. 13 illustrates an example of regions of sensing performed by, for example, the camera 51, the radar 52, the LiDAR 53, and the ultrasonic sensor 54 of the external recognition sensor 25. Note that the figure schematically illustrates the vehicle as viewed from above, where a left-end side in the figure is a side of a front end (the front) of the vehicle, and a right-end side in the figure is a side of a rear end (the rear) of the vehicle.

A sensing region 101F and a sensing region 101B are examples of regions of sensing performed by the ultrasonic sensor 54. The sensing region 101F covers a region around the front end of the vehicle by use of a plurality of ultrasonic sensors 54. The sensing region 101B covers a region around the rear end of the vehicle by use of a plurality of ultrasonic sensors 54.

Results of sensing performed on the sensing region 101F and the sensing region 101B are used to, for example, assist the vehicle in parking.

A region from a sensing region 102F to a sensing region 102B is an example of a region of sensing performed by the radar 52 used for a short distance and a middle distance. The sensing region 102F covers a region that is situated ahead of the vehicle and farther away from the vehicle than the sensing region 101F. The sensing region 102B covers a region that is situated behind the vehicle and farther away from the vehicle than the sensing region 101B. A sensing region 102L covers a region around a rear portion of a left lateral side of the vehicle. A sensing region 102R covers a region around a rear portion of a right lateral side of the vehicle.

A result of sensing performed on the sensing region 102F is used to, for example, detect, for example, a vehicle or pedestrian situated ahead of the vehicle. A result of sensing performed on the sensing region 102B is used for, for example, a function of preventing collision from occurring behind the vehicle. Results of sensing performed on the sensing region 102L and the sensing region 102R are used to, for example, detect an object situated in a region of a blind spot on the lateral side of the vehicle.

A region from a sensing region 103F to a sensing region 103B is an example of a region of sensing performed by the camera 51. The sensing region 103F covers a region that is situated ahead of the vehicle and farther away from the vehicle than the sensing region 102F. The sensing region 103B covers a region that is situated behind the vehicle and farther away from the vehicle than the sensing region 102B. A sensing region 103L covers a region around the left lateral side of the vehicle. A sensing region 103R covers a region around the right lateral side of the vehicle.

A result of sensing performed on the sensing region 103F can be used for, for example, recognition of a traffic light and a traffic sign, a system for assisting in preventing deviation from a lane, and a system for automatically controlling a headlight. A result of sensing performed on the sensing region 103B can be used for, for example, parking assistance and a surround view system. Results of sensing performed on the sensing region 103L and the sensing region 103R can be used for, for example, a surround view system.

A sensing region 104 is an example of a region of sensing performed by the LiDAR 53. The sensing region 104 covers a region that is situated ahead of the vehicle and farther away from the vehicle than the sensing region 103F. On the other hand, the sensing region 104 has a smaller range in the right-and-left direction of the vehicle than the sensing region 103F.

A result of sensing performed on the sensing region 104 is used to detect, for example, an object such as a surrounding vehicle.

A sensing region 105 is an example of a region of sensing performed by the radar 52 used for a long distance. The sensing region 105 covers a region that is situated ahead of the vehicle and farther away from the vehicle than the sensing region 104. On the other hand, the sensing region 105 has a smaller range in the right-and-left direction of the vehicle than the sensing region 104.

A result of sensing performed on the sensing region 105 is used for, for example, adaptive cruise control (ACC), sudden braking, and collision avoidance.

Note that, in addition to the example illustrated in the figure, various configurations may be adopted for the regions of sensing performed by respective sensors that are the camera 51, radar 52, LiDAR 53, and ultrasonic sensor 54 included in the external recognition sensor 25. Specifically, the ultrasonic sensor 54 may also perform sensing on the lateral side of the vehicle, or the LiDAR 53 may perform sensing on a region behind the vehicle. Further, positions for placing the respective sensors are not limited to the examples described above. Furthermore, a single sensor or a plurality of sensors may be provided with respect to each of the sensors.

The present disclosure may also include the following configurations.

(1) A haptic presentation apparatus, including:
a deformable flexible layer that has flexibility, the flexible layer including a front surface that is exposed to be touchable by a user;
a specification layer that specifies a shape of the flexible layer, the specification layer including a front surface that faces a back surface of the flexible layer; and
a haptic generation unit that faces a back surface of the specification layer, the haptic generation unit being moved to a position that corresponds to a touch portion of the flexible layer that is a portion touched by the user, the haptic generation unit deforming the touch portion of the flexible layer.

(2) The haptic presentation apparatus according to (1), in which
the specification layer includes through holes that are each opened to face the flexible layer, and
the haptic generation unit deforms the flexible layer by fluid being sucked in through at least one of the through holes of the specification layer from a direction of the flexible layer and/or by the fluid being discharged through the at least one of the through holes of the specification layer in the direction of the flexible layer.

(3) The haptic presentation apparatus according to (2), in which
the haptic generation unit includes an annular member that is in contact with the back surface of the specification layer,
in the haptic generation unit, the fluid is sucked in from a fluid room that is partitioned off by the back surface of the specification layer and an inner side of the inner annular member, and
the haptic generation unit deforms a region of the flexible layer by the fluid being sucked in from an inner fluid room, the region being specified by a shape of the annular member.

(4) The haptic presentation apparatus according to (2), in which
the haptic generation unit includes
   a ring-shaped inner annular member that is in contact with the back surface of the specification layer, and
   a ring-shaped outer annular member that is in contact with the back surface of the specification layer, the outer annular member surrounding the inner annular member,
in the haptic generation unit, the fluid is sucked in from an outer fluid room that is partitioned off by the back surface of the specification layer, the inner annular member, and the outer annular member, and
the haptic generation unit deforms a region of the flexible layer by the fluid being sucked in from and/or discharged into an inner fluid room that is partitioned off by the back surface of the specification layer and an inner side of the inner annular member, the region being specified by a shape of the annular member.

(5) The haptic presentation apparatus according to (4), in which
the inner annular member of the haptic generation unit is arranged around a single through hole that corresponds to the touch portion,
the haptic generation unit deforms the flexible layer so that the flexible layer has a concave surface, the deformation being performed by the fluid being sucked in from the inner fluid room to pull the flexible layer into the single through hole, and
the haptic generation unit deforms the flexible layer so that the flexible layer has a convex surface, the deformation being performed by the fluid being discharged into the inner fluid room to expand the flexible layer.

(6) The haptic presentation apparatus according to (4) or (5), in which
the inner annular member of the haptic generation unit is arranged correspondingly to the through holes being very small and corresponding to the touch portion,
the haptic generation unit deforms the flexible layer so that the flexible layer has an uneven surface, the deformation being performed by the fluid being sucked in from the inner fluid room to pull the flexible layer into the very small through holes, and
the haptic generation unit deforms the flexible layer so that the flexible layer has a convex surface, the deformation being performed by the fluid being discharged into the inner fluid room to expand the flexible layer.

(7) The haptic presentation apparatus according to any one of (4) to (6), in which
the haptic generation unit vibrates the flexible layer by the fluid being sucked in from and discharged into the inner fluid room repeatedly and continuously.

(8) The haptic presentation apparatus according to any one of (2) to (7), in which
the specification layer includes the through holes having different sizes, and
the haptic generation unit presents different kinds of haptic sensation by the fluid being sucked in from and/or discharged into the through holes having different sizes.

(9) The haptic presentation apparatus according to any one of (1) to (8), in which
the haptic generation unit is further moved in a thickness direction of the flexible layer.

(10) The haptic presentation apparatus according to any one of (1) to (9), further including
a sensor that detects the touch portion of the flexible layer.

(11) The haptic presentation apparatus according to any one of (1) to (10), in which
the front surface of the flexible layer is an inner wall surface of a house that serves as an in-house interface, a surface of each of various electronic apparatuses that serves as a haptic display, an in-vehicle console that serves as an operation-related interface, an in-vehicle wheel that serves as the operation-related interface or a danger notification interface, or an interior wall of a vehicle that serves as the operation-related interface or the danger notification interface.

(12) A haptic presentation method that is performed by a haptic presentation apparatus that includes
a deformable flexible layer that has flexibility, the flexible layer including a front surface that is exposed to be touchable by a user,
a specification layer that specifies a shape of the flexible layer, the specification layer including a front surface that faces a back surface of the flexible layer, and
a haptic generation unit,
the haptic presentation method including:
moving the haptic generation unit facing a back surface of the specification layer to a position that corresponds to a touch portion of the flexible layer that is a portion touched by the user; and
deforming the touch portion of the flexible layer using the haptic generation unit.

(13) A vehicle, including
a haptic presentation apparatus that includes
   a deformable flexible layer that has flexibility, the flexible layer including a front surface that is exposed to be touchable by a user,
   a specification layer that specifies a shape of the flexible layer, the specification layer including a front surface that faces a back surface of the flexible layer, and
   a haptic generation unit that faces a back surface of the specification layer, the haptic generation unit being moved to a position that corresponds to a touch portion of the flexible layer that is a portion touched by the user, the haptic generation unit deforming the touch portion of the flexible layer.

The embodiments and the modifications of the present technology have been described above. Of course the present technology is not limited to the embodiments described above, and various modifications may be made thereto without departing from the scope of the present technology.

### REFERENCE SIGNS LIST

1 haptic presentation apparatus
100 flexible layer
200 specification layer
300 haptic generation unit

1. A haptic presentation apparatus, comprising:
a deformable flexible layer that has flexibility, the flexible layer including a front surface that is exposed to be touchable by a user;
a specification layer that specifies a shape of the flexible layer, the specification layer including a front surface that faces a back surface of the flexible layer; and
a haptic generation unit that faces a back surface of the specification layer, the haptic generation unit being moved to a position that corresponds to a touch portion of the flexible layer that is a portion touched by the user, the haptic generation unit deforming the touch portion of the flexible layer.

2. The haptic presentation apparatus according to claim 1, wherein
the specification layer includes through holes that are each opened to face the flexible layer, and
the haptic generation unit deforms the flexible layer by fluid being sucked in through at least one of the through holes of the specification layer from a direction of the flexible layer and/or by the fluid being discharged through the at least one of the through holes of the specification layer in the direction of the flexible layer.

3. The haptic presentation apparatus according to claim 2, wherein
the haptic generation unit includes an annular member that is in contact with the back surface of the specification layer,
in the haptic generation unit, the fluid is sucked in from a fluid room that is partitioned off by the back surface of the specification layer and an inner side of the inner annular member, and
the haptic generation unit deforms a region of the flexible layer by the fluid being sucked in from an inner fluid room, the region being specified by a shape of the annular member.

4. The haptic presentation apparatus according to claim 2, wherein
the haptic generation unit includes
a ring-shaped inner annular member that is in contact with the back surface of the specification layer, and
a ring-shaped outer annular member that is in contact with the back surface of the specification layer, the outer annular member surrounding the inner annular member,
in the haptic generation unit, the fluid is sucked in from an outer fluid room that is partitioned off by the back surface of the specification layer, the inner annular member, and the outer annular member, and
the haptic generation unit deforms a region of the flexible layer by the fluid being sucked in from and/or discharged into an inner fluid room that is partitioned off by the back surface of the specification layer and an inner side of the inner annular member, the region being specified by a shape of the annular member.

5. The haptic presentation apparatus according to claim 4, wherein
the inner annular member of the haptic generation unit is arranged around a single through hole that corresponds to the touch portion,
the haptic generation unit deforms the flexible layer so that the flexible layer has a concave surface, the deformation being performed by the fluid being sucked in from the inner fluid room to pull the flexible layer into the single through hole, and
the haptic generation unit deforms the flexible layer so that the flexible layer has a convex surface, the deformation being performed by the fluid being discharged into the inner fluid room to expand the flexible layer.

6. The haptic presentation apparatus according to claim 4, wherein
the inner annular member of the haptic generation unit is arranged correspondingly to the through holes being very small and corresponding to the touch portion,
the haptic generation unit deforms the flexible layer so that the flexible layer has an uneven surface, the deformation being performed by the fluid being sucked in from the inner fluid room to pull the flexible layer into the very small through holes, and
the haptic generation unit deforms the flexible layer so that the flexible layer has a convex surface, the deformation being performed by the fluid being discharged into the inner fluid room to expand the flexible layer.

7. The haptic presentation apparatus according to claim 4, wherein
the haptic generation unit vibrates the flexible layer by the fluid being sucked in from and discharged into the inner fluid room repeatedly and continuously.

8. The haptic presentation apparatus according to claim 2, wherein
the specification layer includes the through holes having different sizes, and
the haptic generation unit presents different kinds of haptic sensation by the fluid being sucked in from and/or discharged into the through holes having different sizes.

9. The haptic presentation apparatus according to claim 1, wherein
the haptic generation unit is further moved in a thickness direction of the flexible layer.

10. The haptic presentation apparatus according to claim 1, further comprising
a sensor that detects the touch portion of the flexible layer.

11. The haptic presentation apparatus according to claim 1, wherein
the front surface of the flexible layer is an inner wall surface of a house that serves as an in-house interface, a surface of each of various electronic apparatuses that serves as a haptic display, an in-vehicle console that serves as an operation-related interface, an in-vehicle wheel that serves as the operation-related interface or a danger notification interface, or an interior wall of a vehicle that serves as the operation-related interface or the danger notification interface.

12. A haptic presentation method that is performed by a haptic presentation apparatus that includes
a deformable flexible layer that has flexibility, the flexible layer including a front surface that is exposed to be touchable by a user,
a specification layer that specifies a shape of the flexible layer, the specification layer including a front surface that faces a back surface of the flexible layer, and
a haptic generation unit,
the haptic presentation method comprising:
moving the haptic generation unit facing a back surface of the specification layer to a position that corresponds to a touch portion of the flexible layer that is a portion touched by the user; and
deforming the touch portion of the flexible layer using the haptic generation unit.

13. A vehicle, comprising
a haptic presentation apparatus that includes
a deformable flexible layer that has flexibility, the flexible layer including a front surface that is exposed to be touchable by a user,
a specification layer that specifies a shape of the flexible layer, the specification layer including a front surface that faces a back surface of the flexible layer, and
a haptic generation unit that faces a back surface of the specification layer, the haptic generation unit being moved to a position that corresponds to a touch portion of the flexible layer that is a portion touched by the user, the haptic generation unit deforming the touch portion of the flexible layer.
